(19) United States
(12) Patent Application Publication
(10) Pub. No.: US 2008/0150850 A1
(43) Pub. Date: Jun. 26, 2008

(54) Brightness control method, color conversion apparatus implementing the same, and organic light emitting diode display using the same

(75) Inventors: Kyong-Tae Park, Uijeongbu-si (KR); Chang-Mo Park, Seoul (KR); Alexander Arkhipov, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/998,393

(22) Filed: Nov. 28, 2007

(30) Foreign Application Priority Data
Dec. 19, 2006 (KR) 10-2006-0129733

(51) Int. Cl. G09G 3/32

(52) U.S. Cl. 345/83

(57) ABSTRACT

A color conversion apparatus includes an extraction unit, a summer, a scale vector generation unit, and a multiplier. The extraction unit extracts first white component data and first primary color component data of gray scale, second white component data and second primary color component data of brightness scale in response to gray scale data supplied from the outside. The summer sums the second primary color component data for one frame to calculate a primary color sum, and sums the second white component data for the one frame to calculate a white sum. The scale vector generation unit generates a primary color scale vector and a white scale vector in response to the primary color sum and the white sum. The multiplier multiplies the first primary color component data by the primary color scale vector to output primary color gray scale data scaled thereby, and multiplies the first white component data by the white scale vector to output white gray scale data scaled thereby.

### CROSS-REFERENCE TO RELATED APPLICATIONS

This application claims the benefit of priority from Korean Patent Application No. 10-2006-0129733 filed in the Korean Intellectual Property Office on Dec. 19, 2006, the entire contents of which are incorporated herein by reference herein.

### BACKGROUND OF THE INVENTION

1. Field of the Invention

The present invention relates to an organic light emitting diode display, and more particularly, to a brightness control method that reduces a brightness reduction rate more than a current reduction rate, a color conversion apparatus implementing the same, and an organic light emitting display using the same.

2. Discussion of the Related Art

Generally, an organic light emitting diode (OLED) display is a flat panel display that uses electroluminescence of an organic substance. The OLED emits light using a mechanism in which electrons and holes are injected from electrodes and combined with each other via excitation.

Since an OLED display does not need a separate light source unlike a liquid crystal display (LCD) which require a light source, an OLED consumes less volume and has a reduced weight. Moreover, the OLED displays are used in electronic devices such as mobile terminals, large-scale televisions, and the like due to their advantages of high brightness and fast response.

Most of content data displayed on a large-scale OLED device have a brightness level considerably lower than the maximum brightness level that the OLED display can display. If the OLED display is designed based on the maximum brightness, an excessive driving current may reduce a life span of the OLED display. Accordingly, a large-scale OLED display such as a television and the like needs a brightness control for reducing the driving current of the OLED unlike the LCD.

However, if the brightness control is performed in a conventional OLED display, the brightness of a screen is reduced in proportion to a reduction in the driving current of the OLED. Considering that human vision is more sensitive to brightness than color, the brightness control of the conventional OLED display may cause deterioration of display quality.

### SUMMARY OF THE INVENTION

The present invention provides a brightness control method that controls brightness of primary color data R, G and B and white data W using separate scaling vectors, a color conversion apparatus, and an organic light emitting display.

In one exemplary embodiment, a color conversion apparatus includes: an extraction unit extracting first white component data and first primary color component data of gray scale, second white component data and second primary color component data of brightness scale in response to gray scale data supplied from the outside; a summer summing the second primary color component data for one frame to calculate a primary color sum, and summing the second white component data for the one frame to calculate a white sum; a scale vector generation unit generating a primary color scale vector and a white scale vector in response to the primary color sum and the white sum; and a multiplier multiplying the first primary color component data by the primary color scale vector to output scaled primary color gray data, and multiplying the first white component data by the white scale vector to output scaled white gray data.

In another embodiment, the scale vector generation unit includes: a first adder adding the primary color sum and the white sum to calculate a total sum; a current limiting unit generating a current limiting scale vector if the total sum exceeds a predetermined current limiting value; a current difference calculating unit generating a current difference scale vector in response to the primary color sum, the white sum, and the current limiting scale vector; a subtracter subtracting the current difference scale vector from the current limiting scale vector to output the primary color scale vector; and a second adder adding the current difference scale vector to the current limiting scale vector to output the white scale vector.

In another embodiment, the current difference calculating unit calculates the current difference scale vector by subtracting the white sum from the primary color sum and then multiplying the result thereof by the current limiting scale vector.

In another embodiment, the extraction unit includes: a sequence arranging unit rearranging the gray scale data supplied from the outside according to gray levels to determine first maximum and middle values, and a first minimum value used as the first white component gray scale data; a gamma conversion unit performing gamma conversion on the first maximum, middle and minimum values using a gamma curve to generate second maximum and middle values of the brightness scale, and a second minimum value used as the second white component data, respectively; a primary color component data calculating unit calculating third maximum and middle values, and a third minimum value used as the second primary color component data by subtracting the second minimum value from the second maximum, middle and minimum values, respectively; a sequence restoration unit restoring the sequence of the third maximum, middle and minimum values to determine gray scale data of the brightness scale; and an inverse gamma conversion unit performing inverse gamma conversion on the gray scale data of the brightness scale using the gamma curve to generate the first primary color component data.

In another exemplary embodiment, a color conversion apparatus includes: a sequence arranging unit rearranging gray scale data supplied from the outside according to gray levels to determine a first maximum value, a first middle value, and a first minimum value; a gamma conversion unit performing gamma conversion on the first maximum, middle and minimum values using a gamma curve to generate a second maximum value, a second middle value, and a second minimum value of brightness scale, respectively; a primary color component data calculating unit calculating a third maximum value, a third middle value, and a third minimum value by subtracting the second minimum value from the second maximum, middle and minimum values, respectively; a sequence restoration unit restoring the sequence of the third maximum, middle and minimum values to determine gray scale data of the brightness scale; an inverse gamma conversion unit performing inverse gamma conversion on the gray scale data of the brightness scale using the gamma curve to generate primary color component data; a first summer summing the third minimum value for one frame to calculate a primary color sum; a second summer summing the second minimum value for the one frame to calculate a white sum; a scale vector generation unit generating a primary color scale vector and a white scale vector in response to the primary color sum and the white sum; a first multiplier multiplying the primary color component data of the gray scale by the primary color scale vector to output scaled primary color gray data; and a second multiplier multiplying the white component data of the gray scale by the white scale vector to output scaled white gray data.

In still another exemplary embodiment, an organic light emitting diode display includes: a color conversion unit extracting first white component data and first primary color component data from first data input from the outside, and generating second data by scaling the white component data using a white scale vector and scaling the primary color component data using a primary color sale vector; a scan driver providing a scan signal; a data driver providing an analog voltage corresponding to a signal of the second data; and a display panel including a plurality of organic light emitting diodes emitting lights according to a drive current provided in response to the scan signal and the analog voltage.

In another embodiment, the first data is 3-color gray scale data and the second data is 4-color gray scale data including white.

In a further exemplary embodiment, a brightness control method includes: extracting first white component data and first primary color component data of gray scale, second white component data and second primary color component data of brightness scale in response to gray scale data supplied from the outside; calculating a primary color sum by summing the second primary color component data for one frame, and calculating a white sum by summing the second white component data for the one frame; generating a primary color scale vector and a white scale vector in response to the primary color sum and the white sum; and multiplying the first primary color component data by the primary color scale vector to output scaled primary color gray data, and multiplying the first white component data by the white scale vector to output scaled white graydata scaled thereby.

In another embodiment, in the extracting step, the gray scale data is 3-color gray scale data, and the extracting step includes rearranging the 3-color gray sale data according to gray levels to determine a maximum value, a middle value and a minimum value and providing the minimum value as the first white component data.

In another embodiment, the extracting step includes performing gamma conversion on the first white and primary color component data of the gray scale to generate the second white component data and the second primary color component data of the brightness scale.

In another embodiment, the scale vector generating step includes: calculating a total sum by adding the primary color sum and the white sum; generating a current limiting scale vector if the total sum exceeds a predetermined current limiting value; generating a current difference scale vector by subtracting the white sum from the primary color sum and then multiplying the result thereof by the current limiting scale vector; generating the primary color scale vector by subtracting the current difference scale vector from the current limiting scale vector and outputting the same; and generating the white scale vector by adding the current difference scale vector to the current limiting scale vector and outputting the same.

A better understanding of the above and many other features and advantages of the present invention will be obtained from a consideration of the detailed description below of some exemplary embodiments thereof, taken in conjunction with the appended drawings, wherein like reference numerals are used to identify like elements illustrated in one or more of the figures thereof.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an OLED display according to an exemplary embodiment of the present invention;

FIG. 2 is a block diagram of the color conversion unit shown in FIG. 1;

FIG. 3 is a block diagram of the scale vector generation unit shown in FIG. 2;

FIG. 4 is a plot illustrating the operation of a current limiting unit shown in FIG. 3;

FIG. 5 is a plot illustrating the operation of a current difference calculating unit shown in FIG. 3;

FIG. 6 is a graph comparing current amounts between a conventional OLED display and an OLED display according to an exemplary embodiment of the present invention after brightness control; and

FIGS. 7A to 7C are plots comparing current distributions between the conventional OLED display and the OLED display according to an exemplary embodiment of the present invention after brightness control.

### DETAILED DESCRIPTION OF THE INVENTION

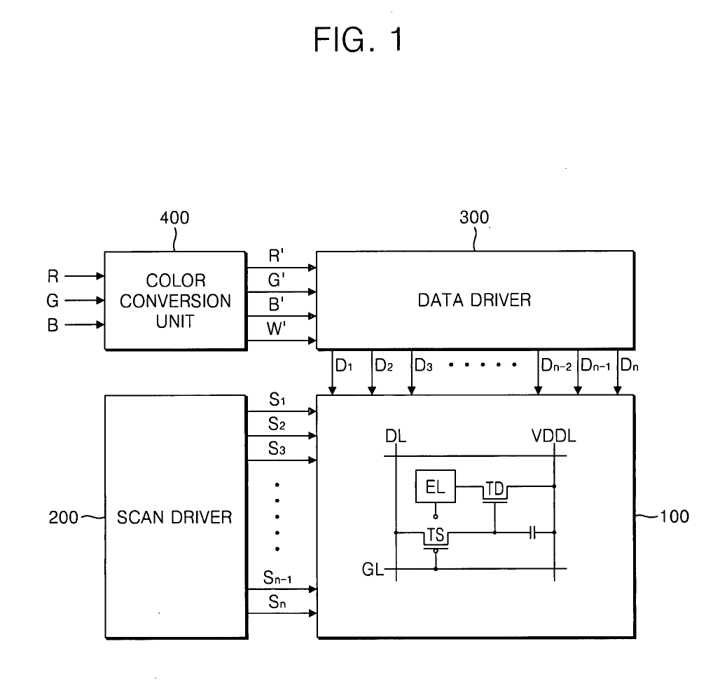

FIG. 1 is a block diagram of an OLED display according to an exemplary embodiment of the present invention.

Referring to FIG. 1, an OLED display according to an exemplary embodiment of the present invention includes a display panel 100, a scan driver 200, a data driver 300, and a color conversion unit 400.

The display panel 100 includes a plurality of data lines DL transmitting data signals D1 to Dₙ, a plurality of scan lines GL transmitting scan signals S1 to Sₙ, and a plurality of current supply lines VDDL supplying a power voltage via one end thereof. In this case, the data lines, the scan lines and the current supply lines are arranged in the form of a matrix form.

Moreover, the display panel 100 includes a switching element TS, an OLED EL, and a driving element TD. The switching element TS includes an input terminal connected to the data line DL, a control terminal connected to the scan line GL, and an output terminal outputting data signals D1 to Dₙ in response to scan signals S1 to Sₙ, respectively. The OLED EL is connected to the output terminal of the driving element TD to emit light corresponding to a current applied via the driving element TD.

The driving element TD includes an input terminal connected to the current supply line VDDL, an output terminal connected to the other end of the OLED EL, and a control terminal connected to the output terminal of the switching element TS. The driving element TD controls the flow of a driving current provided to the OLED EL in response to the data signals D1 to Dₙ applied to the control terminal thereof via the switching element TS.

The scan driver 200 sequentially provides a plurality of scan signals S1 to Sₙ to the scan lines GL of the display panel 100.

The data driver 300 receives RGBW gray scale data R′, G′, B′ and W′ from the color conversion unit 400, converts the received data to data signals D1 to Dₙ of analog voltage, and then provides the same to the data lines DL of the display panel 100.

The color conversion unit 400 converts the RGB gray scale data R, G and B supplied from the outside to RGBW gray scale data R′, G′, B′ and W′ and then provides the same to the data driver 300. In this case, the RGBW gray scale data R′, G′, B′ and W′ are 4-color gray scale data generated by performing brightness control on 3-color RGB gray scale data R, G and B. The color conversion unit 400 scales white gray scale data extracted from the RGB gray scale data R, G and B and primary color gray scale data using a separate scale vector.

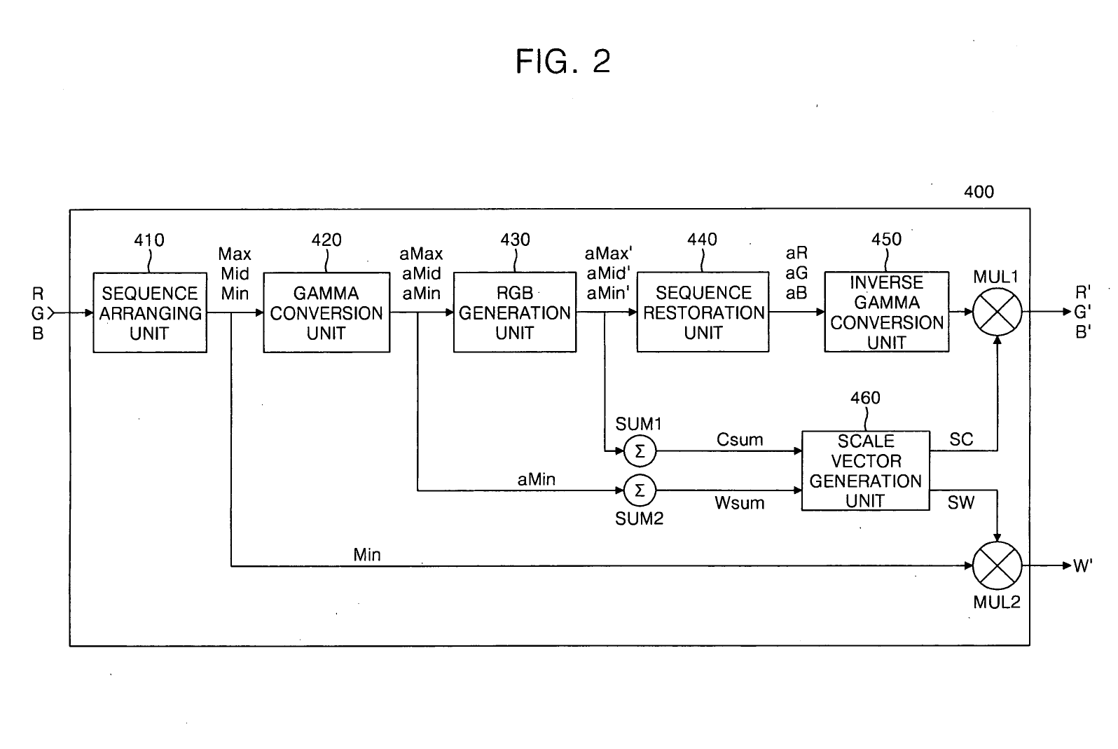

The configuration of the color conversion unit 400 is described in detail with reference to FIG. 2 as follows.

FIG. 2 is a block diagram of an embodiment of color conversion unit 400 shown in FIG. 1.

Referring to FIG. 2, a color conversion unit 400 includes a sequence arranging unit 410, a gamma conversion unit 420, an RGB generation unit 430, a sequence restoration unit 440, an inverse gamma conversion unit 450, a first summer SUM1, a second summer SUM2, a scale vector generation unit 460, a first multiplier MUL1, and a second multiplier MUL2.

The sequence arranging unit 410 rearranges the RGB gray scale data R, G and B supplied from the outside according to gray levels to determine a maximum value Max, a middle value Mid, and a minimum value Min of the RGB gray scale data R, G, and B. The sequence arranging unit 410 provides the maximum value Max, the middle value Mid and the minimum value Min to the gamma conversion unit 420 and also provides the minimum value Min to the second multiplier MUL2. In this case, the minimum value Min provided to the second multiplier MUL2 constitutes white component gray scale data extracted from the RGB gray scale data R, G and B.

The gamma conversion unit 420 performs gamma conversion on the maximum, middle and minimum values Max, Mid and Min of the gray scale supplied from the sequence arranging unit 410 using a gamma curve to generate maximum, middle and minimum values aMax, aMid and aMin of brightness scale. In this case, the gamma curve is a curve that represents a relationship between the gray scale and the brightness, and the gamma conversion is to convert the gray scale to the brightness using the gamma curve.

The gamma conversion unit 420 provides the maximum, middle, and minimum values aMax, aMid and aMin of the brightness scale to the RGB generation unit 430 and also the minimum value aMin of the brightness scale to the second summer SUM2. In this case, the minimum value aMin provided to the second summer SUM is proportional to a driving current for displaying white.

The RGB generation unit 430 calculates RGB data components, which are maximum, middle and minimum values aMax′, aMid′ and aMin′ of the brightness scale, by subtracting the white data component of the brightness scale from the maximum, middle and minimum values aMax, aMid and aMin of the brightness scale supplied from the gamma conversion unit 420. More particularly, the RGB data components, i.e., the maximum, middle and minimum values aMax′, aMid′ and aMin′ can be obtained by Formula 1:

aMax′=aMax−aMin, aMid′=aMid−aMin, aMin′=aMin−aMin [Formula 1]

wherein ‘aMin’ represents a brightness scale value corresponding to the white gray scale data determined by the sequence arranging unit 410.

The sequence restoration unit 440 provides RGB data aR, aG and aB of the brightness scale by restoring the sequence of the maximum, middle and minimum values aMax′, aMid′ and aMin′ of the brightness scale which are the RGB data components supplied from the RGB generation unit 430.

The inverse gamma conversion unit 450 performs inverse gamma conversion on the RGB data aR, aG and aB of the brightness scale supplied from the sequence restoration unit 440 using a gamma curve to generate the RGB data of the gray scale. Preferably, the gamma curve is the same as that used by the sequence arranging unit 410. Moreover, the inverse gamma conversion is to re-convert the brightness to the gray scale using the gamma curve. The inverse gamma conversion unit 450 provides gray scale RGB data to the first multiplier MUL1.

The first summer SUM1 sums the maximum, middle and minimum values aMax′, aMid′ and aMin′ supplied from the RGB generation unit 430 in the unit of a frame to calculate a primary color sum Csum. In this case, the primary color sum Csum is proportional to a primary color driving current displaying RGB component data in the current frame.

The second summer SUM2 sums the minimum value aMin of the brightness scale supplied from the gamma conversion unit 420 in the unit of a frame to calculate a white sum Wsum. In this case, the white sum Wsum is proportional to a white driving current displaying white component data in the current frame.

The scale vector generation unit 460 receives the primary color sum Csum and the white sum Wsum from the first and second summers SUM1 and SUM2 and then generates a primary color scale vector SC and a white scale vector SW, respectively. The scale vector generation unit 460 provides the primary color and white scale vectors SC and SW to the first and second multipliers MULL and MUL2, respectively.

The first multiplier MULL multiplies the gray scale RGB data supplied from the inverse gamma conversion unit 450 by the primary color scale vector SC supplied from the scale vector generation unit 460 and outputs scaled primary color gray data R′, G′ and B′.

The second multiplier MUL2 multiplies the white component gray scale data supplied from the sequence arranging unit 410 by the white scale vector SW supplied from the scale vector generation unit 460 and outputs scaled white gray data W′.

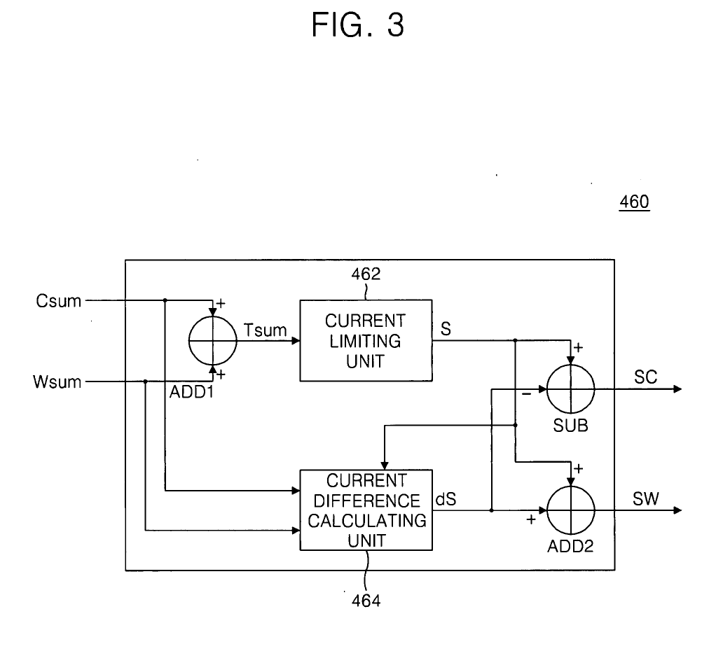

The configuration of the scale vector unit 460 is described below in detail with reference to FIG. 3 as follows.

FIG. 3 is a block diagram of an embodiment of scale vector generation unit 460 shown in FIG. 2.

Referring to FIG. 3, the scale vector generation unit 460 includes a first adder ADD1, a current limiting unit 462, a current difference calculating unit 464, a subtracter SUB, and a second adder ADD2.

The first adder ADD1 generates a total sum Tsum by adding the primary color sum Csum and the white sum Wsum and then provides the total sum Tsum to the current limiting unit 462. In this case, the total sum Tsum is proportional to a total driving current supplied to the OLED to display data for one frame.

If the total sum Tsum supplied from the first adder ADD1 exceeds a predetermined current limiting value Rsum, the current limiting unit 462 calculates a current limiting scale vector S. In this case, the current limiting scale vector S limits a driving current flowing in the OLED by scaling the total sum Tsum.

The current difference calculating unit 464 calculates a current difference scale vector dS in response to receipt of primary color sum Csum, the white sum Wsum, and the current limiting scale vector S. The current difference scale vector dS can be calculated by Formula 2:

ds=(Csum−Wsum)×S [Formula 2]

The subtracter SUB subtracts the current difference scale vector dS supplied from the current difference calculating unit 464 from the current limiting scale vector S supplied from the current limiting unit 462 generates the primary color scale vector SC and outputs the same. The primary color scale vector SC can be represented by Formula 3:

SC=S−dS [Formula 3]

The second adder ADD2 calculates the white scale vector SW by adding the current limiting scale vector S supplied from the current limiting unit 462 and the current difference scale vector dS supplied from the current difference calculating unit 464 and outputs the same. The white scale vector SW can be represented by Formula 4:

SW=S+dS [Formula 4]

A brightness control method according to another embodiment of the present invention is described below with reference to the operations of the color conversion unit according to the present invention as follows.

In this method, the sequence arranging unit 410 arranges three color RGB data R, G and B in the sequential order of Max, Mid, and Min according to the size of the gray scale and then determines the smallest gray scale value Min from the three color RGB data R, G and B as the white component gray scale data.

Subsequently, the gamma conversion unit 420 performs gamma conversion on the Max, Mid and Min of the gray scale to generate aMax, aMid and aMin of the brightness scale. In this case, the aMin of the brightness scale corresponds to the white component gray scale data and is proportional to a driving current for displaying a white component. The second summer SUM2 sums the white component data aMin of the brightness scale for one frame to calculate a white sum Wsum. The white sum Wsum is proportional to a driving current for displaying a white component for one frame.

Next, the RGB generation unit 430 determines primary color component data aMax′, aMid′ and aMin′ of the brightness scale by subtracting the aMin of the brightness scale from each of the aMax, aMid and aMin of the brightness scale. The first summer SUM1 sums the primary color component data aMax′, aMid′ and aMin′ of the brightness scale for one frame to calculate a primary color sum Csum. The primary color sum Csum is proportional to a driving current for displaying a primary color component for one frame.

The inverse gamma conversion unit 450 then performs inverse gamma conversion on the RGB data aR, aG and aB of the brightness scale restored by the sequence restoration unit 440 to generate the RGB gray scale data of the gray scale.

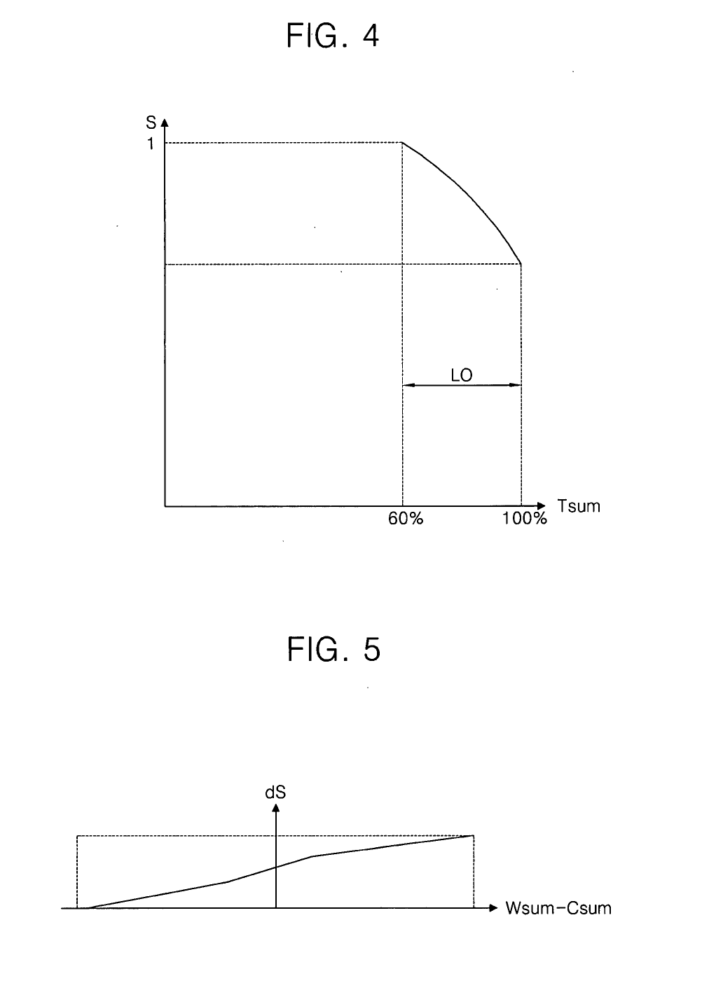

Subsequently, the scale vector generation unit 460 calculates a primary color scale vector SC and a white scale vector SW using the white sum Wsum and the primary color sum Csum. In particular as shown in FIG. 3, the first adder ADD1 calculates a total sum Tsum by adding the white sum Wsum and the primary color sum Wsum. The current limiting unit 462 then selects a current limiting scale vector S corresponding to the total sum Tsum using the curve illustrated in FIG. 4 plotted showing the total sum with respect to the current limiting scale vector S.

The curve illustrated in FIG. 4 shows that the current limiting unit 462 can calculate the current limiting scale vector S by performing a current limiting operation, if the total sum Tsum exceeds 60% of the driving current for displaying a maximum brightness. The current limiting scale vector S corresponding to the total sum Tsum can be adjusted to be selected as an optimal state by a test value. Reference symbol ‘LO’ denotes a section in which the current limiting unit 462 carries out the current limiting operation.

The current difference calculating unit 464 calculates a current difference scale vector dS by subtracting the white sum Wsum from the primary color sum Csum, and then multiplying the result thereof by the current limiting scale vector S calculated by the current limiting unit 462. FIG. 5 shows a curve illustrating a relationship between the value, obtained by subtracting the white sum Wsum from the primary color sum Csum, with respect to the current limiting scale vector S. FIG. 5 shows that, if the primary color sum Csum is greater than the white sum Wsum, the current difference scale vector dS increases, whereas, if the primary color sum Csum is smaller than the white sum Wsum, the current difference scale vector dS decreases.

Preferably, the current difference sale vector dS has a value greater than zero. Namely, the brightness control method according to the embodiment of the present invention is effective in case that the white sum Wsum is greater than the primary color sum Csum.

The subtracter SUB subtracts the current difference scale vector dS from the current limiting scale vector S to generate a primary color scale vector SC, and the second adder ADD2 adds the current difference scale vector dS to the current limiting scale vector S to generate a white scale vector SW.

Finally, as shown in FIG. 2 the first multiplier MUL1 multiplies the RGB gray scale data of the gray scale data received from the inverse gamma conversion unit 450 by the primary color scale vector SC and outputs scaled primary color gray data R′, G′ and B′. The second multiplier MUL2 multiplies the white component data of the gray scale MIN received from the sequence arranging unit 410 by the white scale vector SW and outputs scaled white gray data W′.

In the OLED display and the brightness control method according to the embodiment of the present invention, four color RGBW data are generated by scaling the white component data and the primary color component data, extracted from three color RGB data, using the separately generated white scale vector and the primary color scale vector, respectively.

Accordingly, it is possible to adjust the reduction amount of the driving current for displaying the white component data through the brightness control even if the current provided to the OLED is reduced.

In particular, referring to Formulas 3 and 4, it can be understood that, if the current difference scale vector dS is large, the white scale vector SW increases, while the primary color scale vector SC decreases. That is, it can be understood that the greater the white component data displayed on the screen is than the primary component, the greater the white scale SW becomes than the primary color scale vector SC.

Accordingly, it is possible to decrease the reduction amount of the driving current for displaying the white component, even if the total driving current is reduced by limiting the current provided to the PLED to a predetermined level.

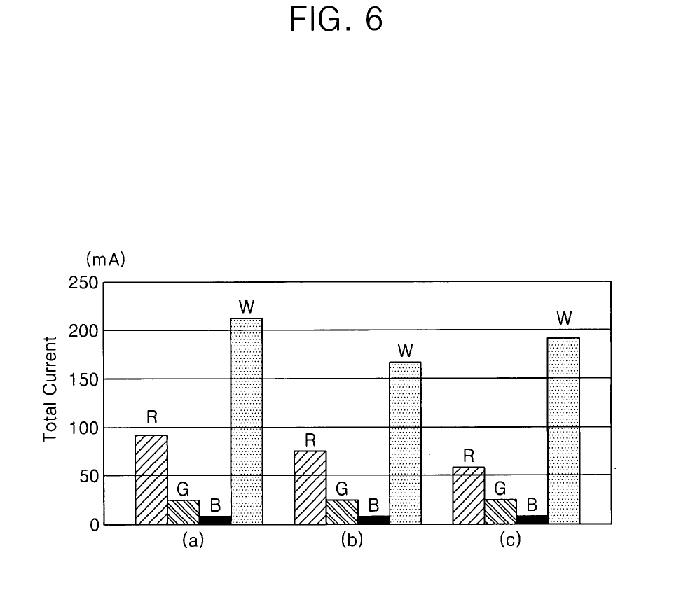

FIG. 6 is a graph comparing current amounts between a conventional OLED display and an OLED display according to an exemplary embodiment of the present invention after brightness control.

In FIG. 6, graph (a) shows currents of RGB and white components of original RGB gray scale data.

Graph (b) shows currents of RGB and white components in a case where the currents of the original RGB gray scale data are limited by the conventional brightness control method. If the total current supplied to the OLED is reduced 20% in comparison with graph (a) of FIG. 6 by the conventional brightness control method (in case of scale vector 90%), the current of the white component is reduced about 20%. Considering that the current of the white component is proportional to the brightness, it can be observed that the brightness is reduced at the same rate as the current reduction rate.

Graph (c) shows currents of RGB and white components in a case where the currents of the original RGB gray scale data are limited by the brightness control method according to the embodiment of the present invention. If the total current supplied to the OLED is reduced 20% in comparison with graph (a) of FIG. 6, by the brightness control method according to the embodiment of the present invention (in case of white scale vector 94% and primary color scale vector 84%), the current of the white component is reduced 14.84%. In comparison with (b) of FIG. 6 that shows the current limiting result according to the conventional brightness control method, it can be observed that brightness efficiency is increased about 6.25%.

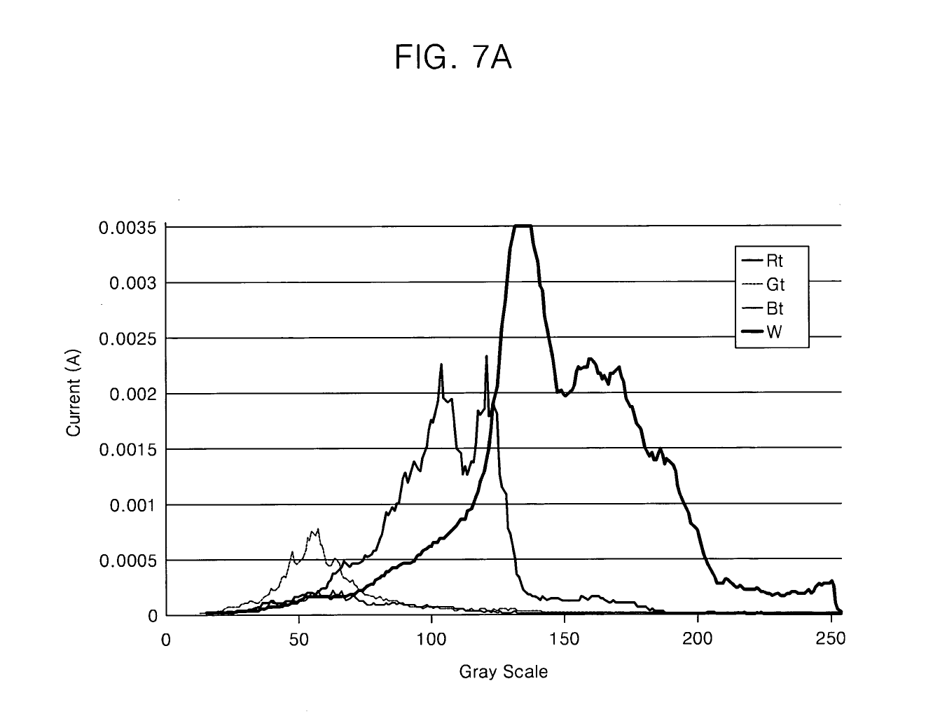

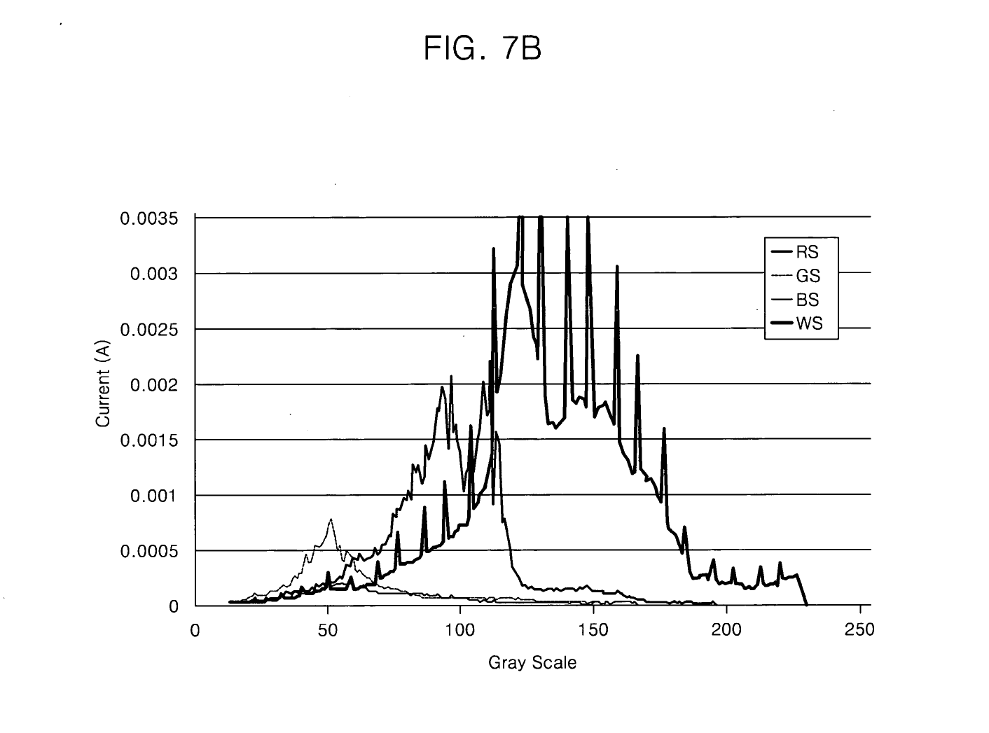

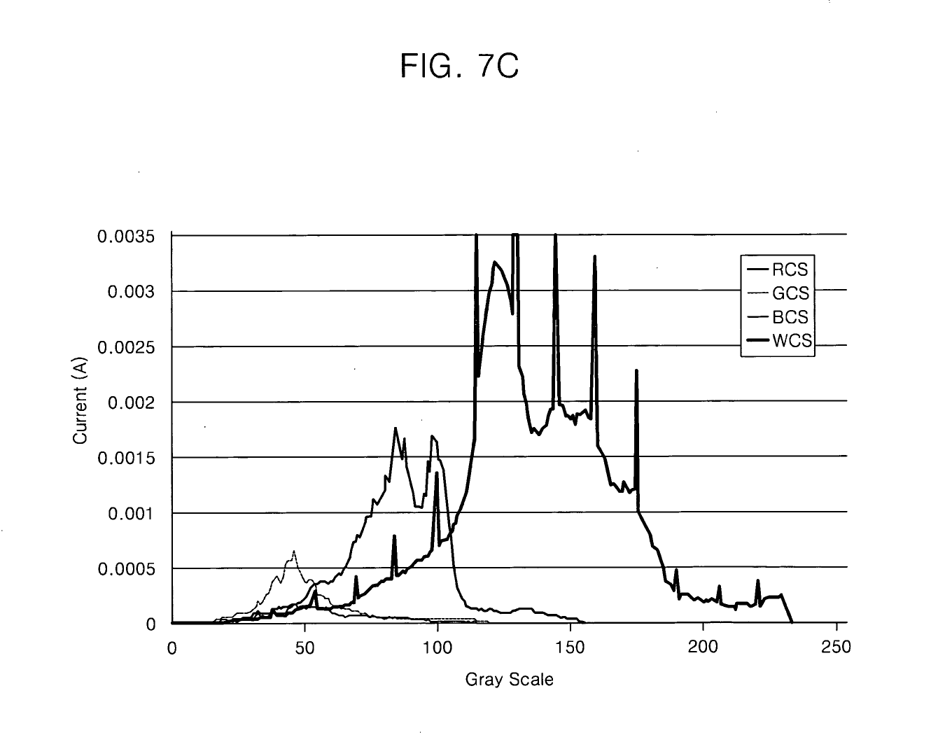

FIGS. 7A to 7C illustrate curves comparing current distributions between the conventional OLED display and the OLED display according to the embodiment of the present invention after brightness control. FIG. 7A illustrates a curve showing current distribution of the RGB and white components of the original RGB gray scale data per gray scale. The curves in FIG. 7B illustrate the current distribution of the RGB and white components in a case where the currents of the original RGB gray scale data per gray scale are limited by the conventional brightness control method. The curves in FIG. 7C illustrate current distribution of the RGB and white components in a case where the currents of the original RGB gray scale data per gray scale are limited by the brightness control method according to the embodiment of the present invention.

Referring to FIGS. 7A to 7C, as described with reference to FIG. 6, it can be seen that the brightness in a case where the currents are limited by separately scaling the RGB and white components extracted from the original RGB gray scale data using the primary color scale vector and the white scale vector using the brightness control method according to the embodiment of the present invention is improved more than that in a case where the currents are limited by scaling the RGV and white components extracted from the original RGB gray scale data using a single scale vector by the conventional brightness control method.

In more detail, it can be ascertained that, if comparing FIG. 7B with FIG. 7C, the white component current according to the brightness control method of the present invention is reduced less than that according the conventional brightness control method, and the RGB component currents according to the brightness control method of the present invention are reduced more than those according to the conventional brightness control method. Since human eyesight is more sensitive to brightness than color in general, it is perceived that the image quality is improved when the brightness is increased, even though the RGB components are reduced. Hence, the brightness control method and the OLED display according to the present invention provide improved image quality in comparison with those according to the conventional method.

As described above, since the brightness of the primary color data (R, G, B) and white data (W) is adjusted using separate scaling vectors, the brightness control method and the OLED display of the present invention can reduce the brightness at a lower rate than the current reduction rate, even if the current supplied to the OLED is reduced and limited.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A color conversion apparatus comprising:
an extraction unit adapted to generate first white component data of gray scale, first primary color component data of gray scale, second white component data of brightness scale and second primary color component data of brightness scale in response to externally provided gray scale data;
a first summer adapted to sum the second primary color component data for one frame to calculate a primary color sum, and a second summer adapted to sum the second white component data for the one frame to calculate a white sum;
a scale vector generation unit adapted to generate a primary color scale vector and a white scale vector in response to receipt of the primary color sum and the white sum; and
a first multiplier adapted to multiply the first primary color component data by the primary color scale vector and provide at an output scaled primary color gray data, and a second multiplier being operative to multiply the first white component data by the white scale vector and provide at an output scaled white gray data.

2. The color conversion apparatus of claim 1, wherein the scale vector generation unit comprises:
a first adder being operative to add the primary color sum and the white sum and calculate and provide at an output a total sum;
a current limiting unit being operative to generate a current limiting scale vector if the total sum exceeds a predetermined current limiting value;
a current difference calculating unit being operative to generate a current difference scale vector in response to the primary color sum, the white sum, and the current limiting scale vector;
a subtractor being operative to subtract the current difference scale vector from the current limiting scale vector and provide at an output the primary color scale vector; and
a second adder being operative to add the current difference scale vector to the current limiting scale vector and provide at an output the white scale vector.

3. The color conversion apparatus of claim 2, wherein the current difference calculating unit is operative to calculate the current difference scale vector by subtracting the white sum from the primary color sum and then multiplying the result thereof by the current limiting scale vector.

4. The color conversion apparatus of claim 2, wherein the current limiting unit has an input coupled to the first adder to received total sum;
wherein the current difference calculating unit has inputs coupled to receive the primary color sum, the white sum and the current limiting scale vector;
wherein the subtractor has inputs coupled to receive the current difference scale vector and the current limiting scale vector; and
wherein the second adder has inputs coupled to receive the current difference scale vector and the current limiting vector.

5. The color conversion apparatus of claim 1, wherein the extraction unit comprises:
a sequence arranging unit being operative to arrange the externally provided gray scale data according to gray levels to determine first maximum and middle values, and a first minimum value representing the first white component data;
a gamma conversion unit being operative to perform gamma conversion on the first maximum, middle and minimum values using a gamma curve and generate second maximum and middle values of the brightness scale, and a second minimum value of the brightness scale, the second minimum value representing the second white component data, respectively;
a primary color component data calculating unit being operative to calculate third maximum and middle values, and a third minimum value used as the second primary color component data by subtracting the second minimum value from the second maximum, middle and minimum values, respectively;
a sequence restoration unit being operative to restore the sequence of the third maximum, middle and minimum values and generate gray data of the brightness scale; and
an inverse gamma conversion unit being operative to perform inverse gamma conversion on the gray data of the brightness scale using a gamma curve to generate the first primary color component data.

6. The color conversion apparatus of claim 5, wherein the gamma conversion unit has at least one input coupled to receive the first maximum, middle and minimum values;
wherein the primary color component data calculating unit is coupled to the gamma conversion unit to receive the second maximum, middle and minimum values of the brightness scale;
wherein the sequence restoration unit is coupled to the primary color component data calculating unit; and
wherein the inverse gamma conversion unit is coupled to the sequence restoration unit.

7. A color conversion apparatus comprising:
a sequence arranging unit being operative to arrange externally provided gray scale data according to gray levels to determine a first maximum value, a first middle value, and a first minimum value representing a white component data of gray scale;
a gamma conversion unit being operative to perform gamma conversion on the first maximum, middle and minimum values using a gamma curve and generate second maximum, middle and minimum values of the brightness scale, respectively;
a primary color component data calculating unit being operative to calculate a third maximum value, a third middle value, and a third minimum value by subtracting the second minimum value from the second maximum, middle and minimum values, respectively;
a sequence restoration unit being operative to restore the sequence of the third maximum, middle and minimum values and generate gray data of the brightness scale;
an inverse gamma conversion unit being operative to perform inverse gamma conversion on the gray data of the brightness scale using a gamma curve to generate primary color component data of the gray scale;
a first summer adapted to sum the third minimum value for one frame to calculate a primary color sum;
a second summer adapted to sum the second minimum value for the one frame to calculate a white sum;
a scale vector generation unit adapted to generate a primary color scale vector and a white scale vector in response to receipt of the primary color sum and the white sum;
a first multiplier adapted to multiply the primary color component data of the gray scale by the primary color scale vector to output scaled primary color gray data; and
a second multiplier adapted to multiply the white component gray data of the gray scale by the white scale vector to generate scaled white gray data.

8. The color conversion apparatus of claim 7, wherein the gamma conversion unit has at least one input coupled to receive the first maximum, middle and minimum values;
wherein the primary color component data calculating unit is coupled to the gamma conversion unit to receive the second maximum, middle and minimum values of the brightness scale;
wherein the sequence restoration unit is coupled to the primary color component data calculating unit; and
wherein the inverse gamma conversion unit is coupled to the sequence restoration unit.

9. The color conversion apparatus of claim 7, wherein the scale vector generation unit comprises:
a first adder being operative to add the primary color sum and the white sum to calculate a total sum;
a current limiting unit being operative to generate a current limiting scale vector if the total sum exceeds a predetermined current limiting value;
a current difference calculating unit being operative to calculate a current difference scale vector by subtracting the white sum from the primary color sum and multiply the result thereof by the current limiting scale vector;
a subtracter being operative to subtract the current difference scale vector from the current limiting scale vector and provide at an output the primary color scale vector; and
a second adder being operative to add the current difference scale vector to the current limiting scale vector and provide at an output the white scale vector.

10. An organic light emitting diode display comprising:
a color conversion unit being operative to extract first white component data and first primary color component data from externally supplied first data, and being operative to generate second data by scaling the first white component data using a white scale vector and scaling the first primary color component data using a primary color sale vector;
a scan driver being operative to provide a scan signal;
a data driver being operative to provide an analog voltage responsive to receipt of the second data; and
a display panel including a plurality of organic light emitting diodes being operative to emit light in response to receipt of a drive current provided in response to the scan signal and the analog voltage.

11. The organic light emitting diode display of claim 10, wherein the display panel is coupled to the data driver and the scan driver.

12. The organic light emitting diode display of claim 10, wherein the first data is 3-color gray scale data and the second data is 4-color gray scale data including white.

13. The organic light emitting diode display of claim 10, wherein the color conversion unit comprises:
an extraction unit adapted to generate first white component data of gray scale, first primary color component data of gray scale, second white component data of brightness scale and second primary color component data of brightness scale in response to externally provided gray scale data;
a first summer adapted to sum the second primary color component data for one frame to calculate a primary color sum, and a second summer adapted to sum the second white component data for the one frame to calculate a white sum;
a scale vector generation unit adapted to generate a primary color scale vector and a white scale vector in response to receipt of the primary color sum and the white sum; and
a first multiplier adapted to multiply the first primary color component data by the primary color scale vector and provide at an output scaled primary color gray data, and
a second multiplier being operative to multiply the first white component gray scale data by the white scale vector and provide at an output scaled white gray data.

14. The organic light emitting diode display of claim 13, wherein the scale vector generation unit comprises:
a first adder being operative to add the primary color sum and the white sum to calculate a total sum;
a current limiting unit being operative to generate a current limiting scale vector if the total sum exceeds a predetermined current limiting value;
a current difference calculating unit being operative to calculate a current difference scale vector by subtracting the white sum from the primary color sum and multiply the result thereof by the current limiting scale vector;
a subtracter being operative to subtract the current difference scale vector from the current limiting scale vector and provide at an output the primary color scale vector; and
a second adder being operative to add the current difference scale vector to the current limiting scale vector and provide at an output the white scale vector.

15. A brightness control method comprising:
extracting first white component data of gray scale and first primary color component data of gray scale, second white component data of brightness scale and second primary color component data of brightness scale in response to gray scale data;
calculating a primary color sum by summing the second primary color component data for one frame, and calculating a white sum by summing the second white component data for the one frame;
generating a primary color scale vector and a white scale vector in response to the primary color sum and the white sum; and
multiplying the first primary color component data by the primary color scale vector to output scaled primary color gray data, and multiplying the first white component data by the white scale vector to output scaled white gray data.

16. The method of claim 15, wherein, in the extracting step, the gray scale data is 3-color gray scale data, and the extracting step comprises rearranging the 3-color gray scale data according to gray levels to determine a maximum value, a middle value and a minimum value and providing the minimum value as the first white component data.

17. The method of claim 16, wherein the extracting step comprises performing gamma conversion on the first white and primary color component data of the gray scale to generate the second white and primary color component data of the brightness scale.

18. The method of claim 17, wherein the scale vector generating step comprises:
calculating a total sum by adding the primary color sum and the white sum;
generating a current limiting scale vector if the total sum exceeds a predetermined current limiting value;
generating a current difference scale vector by subtracting the white sum from the primary color sum and then multiplying the result thereof by the current limiting scale vector;
generating the primary color scale vector by subtracting the current difference scale vector from the current limiting scale vector and outputting the same; and
generating the white scale vector by adding the current difference scale vector to the current limiting scale vector and outputting the same.
